(19) United States
(12) Patent Application Publication
(10) Pub. No.: US 2015/0220661 A1
(43) Pub. Date: Aug. 6, 2015

(54) INFORMATION PROCESSING APPARATUS, INFORMATION PROCESSING METHOD, AND STORAGE MEDIUM

(71) Applicant: Canon Kabushiki Kaisha, Tokyo (JP)

(72) Inventor: Yoshihito Nanaumi, Kawasaki-shi (JP)

(21) Appl. No.: 14/595,919

(22) Filed: Jan. 13, 2015

(30) Foreign Application Priority Data
Jan. 15, 2014 (JP) 2014-005287

(51) Int. Cl. G06F 17/30; H04L 29/08

(52) U.S. Cl. CPC G06F 17/30991; H04L 67/10

(57) ABSTRACT

An information processing apparatus includes a display control unit configured to execute a job search based on a search condition associated with a folder selected by a user among a plurality of folders associated with search conditions, and to display a search result in association with the selected folder, and a detection unit configured to detect an event related to a job. When the event is detected by the detection unit, the display control unit is configured to execute the job search again based on the search condition associated with the folder selected by the user among the plurality of folders, to display a search result in association with the folder, and is not to execute the job search based on a search condition associated with a folder not selected by the user.

### BACKGROUND OF THE INVENTION

1. Field of the Invention

The present disclosure generally relates to information processing and, more particularly, to an information processing apparatus, an information processing method, and a storage medium in which a search is executed based on a search condition associated with a folder.

2. Description of the Related Art

Managing systems are known that manage finished FX transmission data. Japanese Patent Application Laid-Open No. 2002-157162 discusses a system that notifies update information of data stored in a database.

However, the technique discussed in Japanese Patent Application Laid-Open No. 2002-157162 involves a high processing cost when the managed data is updated and a display state needs to be changed due to this update event. More specifically, whether the display is to be updated needs to be determined for each registered setting (filter).

### SUMMARY OF THE INVENTION

An information processing apparatus according to an aspect of the present disclosure includes a display control unit configured to execute a job search based on a search condition associated with a folder selected by a user among a plurality of folders associated with search conditions, and to display a search result in association with the selected folder, and a detection unit configured to detect an event related to a job. When the event is detected by the detection unit, the display control unit is configured to execute the job search again based on the search condition associated with the folder selected by the user among the plurality of folders, to display a search result in association with the folder, and is not to execute the job search based on a search condition associated with a folder not selected by the user.

Further features of the present disclosure will become apparent from the following description of exemplary embodiments with reference to the attached drawings.

### BRIEF DESCRIPTION OF THE DRAWINGS

FIG. 1A is a diagram illustrating an example of a system configuration.

FIG. 1B is a block diagram illustrating an example of a hardware configuration of an information processing apparatus.

FIG. 2A is a block diagram illustrating an example of a software configuration of the information processing apparatus.

FIG. 2B is a block diagram illustrating an example of a software configuration of a data management server.

FIG. 3A is a diagram illustrating a user interface (UI) of a client application.

FIG. 3B is a diagram illustrating an example of a filter setting user interface (UI).

FIG. 3C is a diagram illustrating in detail a folder tree view to which a filter condition is set.

FIG. 4 is a diagram illustrating an example of a facsimile (FAX) transmission UI of the client application.

FIG. 5 is a diagram schematically illustrating an example of FAX transmission history data.

FIG. 6 is a flowchart illustrating an example of information processing.

FIGS. 7A, 7B, 7C, and 7D are diagrams illustrating examples of a UI for displaying a FAX transmission history list and a content of related data.

FIG. 8 is a flowchart related to display control processing for a tree display of a tree view.

FIG. 9A is a diagram illustrating a first example of the tree display.

FIG. 9B is a diagram illustrating a second example of the tree display.

FIG. 10 is a flowchart illustrating an example of processing in step S810.

FIG. 11A is a diagram illustrating an example of a state where a folder is expanded.

FIG. 11B is a diagram illustrating an example of a case where six searches are executed.

FIG. 11C is a diagram illustrating an example of events and portions with an increased total number.

FIG. 11D is a diagram illustrating an example of events and portions with an increased total number.

FIG. 11E is a diagram illustrating an example of events and portions with an increased total number.

FIG. 11F is a diagram illustrating an example of events and portions with an increased total number.

### DESCRIPTION OF THE EMBODIMENTS

Various exemplary embodiments, features, and aspects of the disclosure will be described in detail below with reference to the drawings.

### [System Configuration]

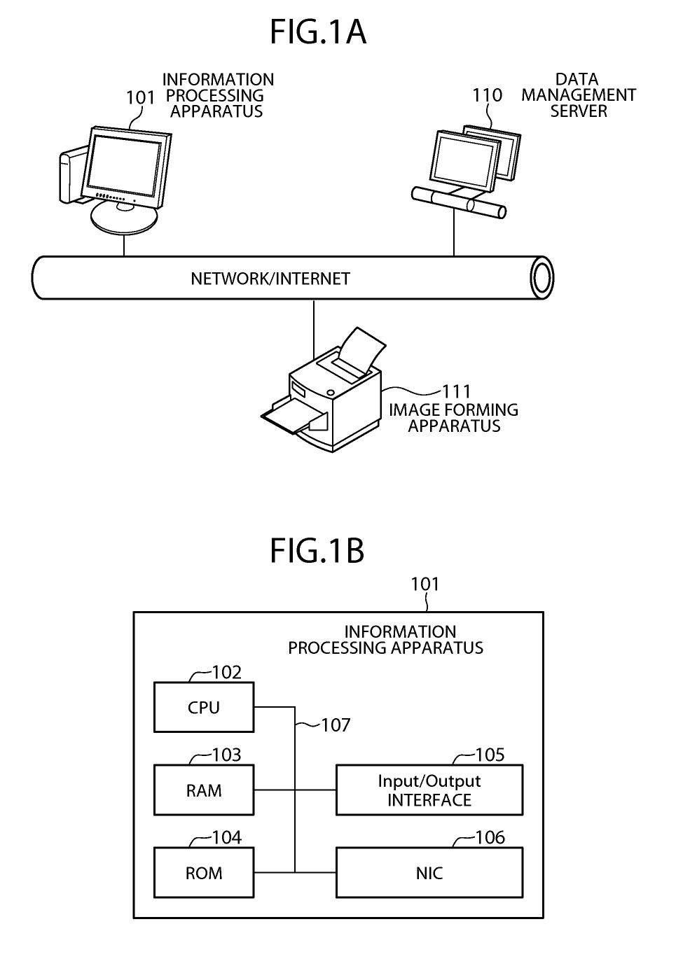

A configuration of a system according to a first exemplary embodiment is described with reference to FIG. 1A. FIG. 1A is a block diagram illustrating an example of the system configuration. An information processing apparatus (computer) 101, which is connected to a network, is connected to the Internet through the network. A data management server 110 and an image forming apparatus 111 are also connected to the network/Internet. The information processing apparatus 101 according to the present exemplary embodiment is a single apparatus as shown in the illustration but a plurality of information processing apparatuses may also be provided. Further, the network and the Internet are communication network lines supporting transmission control protocol/Internet protocol (TCP/IP) and the like, and may be connected by wireless or cable.

### [Hardware Configuration]

A hardware configuration of the information processing apparatus 101 is described in detail with reference to FIG. 1B. A central processing unit (CPU) 102 is a unit that executes various programs to implement various functions in accordance with the programs. A read only memory (ROM) 104 is a unit that stores the various programs and data. A random access memory (RAM) 103 is a unit that stores various types of information, and is also used as a temporary work storage area for the CPU 102. For example, the CPU 102 loads a program or data stored in the ROM 104 onto the RAM 103 and executes the program. An input/output interface 105 is a unit that transmits data to a display connected to the information processing apparatus 101, and receives data from a pointing device. A network interface card (NIC) 106 is a unit for establishing connection between the information processing apparatus 101 and the network. The units described above are capable of transmitting and receiving data to and from each other through a bus 107. As used herein, the term “unit” generally refers to any combination of software, firmware, hardware, or other component, such as circuitry, that is used to effectuate a purpose.

The CPU 102 loads the program stored in the ROM 104 onto the RAM 103, and executes processing in accordance with the loaded program. Thus, a software configuration of the information processing apparatus 101 and processing in a flowchart executed in the information processing apparatus 101 described below are implemented. The functions of the information processing apparatus 101 and processing in the flow chart described below may all or partially be implemented by a dedicated hardware. The same applies to the other apparatuses.

The image forming apparatus 111, having the hardware configuration described above, further includes a FAX unit capable of transmitting and receiving data to and from the units through a bus. The FAX unit is capable of converting a FAX control language received from the information processing apparatus 101 into an image and transmitting the image via an Internet Protocol (IP) through a public line or the Internet. The image forming apparatus 111 further includes a print unit and a scanner unit. The print unit is a unit capable of printing a raster image onto a recording medium. The scanner unit is a unit through which an image can be input.

Similar to the information processing apparatus 101, the image forming apparatus 111 and the data management server 110 include the CPU, the ROM, the RAM, and the NIC, and the CPU of the apparatus executes processing based on a program stored in the ROM and the like within the apparatus to implement functions and the like of the apparatus. For example, the CPU of the data management server 110 executes processing based on a program stored in the ROM to implement a software configuration and the like of the data management server 110 described below.

The data management server 110 further includes a hard disk drive (HDD) and stores a FAX-related transmission image and the like in the HDD. A program of the data management server 110 may be stored in the HDD. Similarly, when the information processing apparatus 101 includes an HDD, a program of the information processing apparatus 101 may be stored in the HDD.

### [Software Configuration]

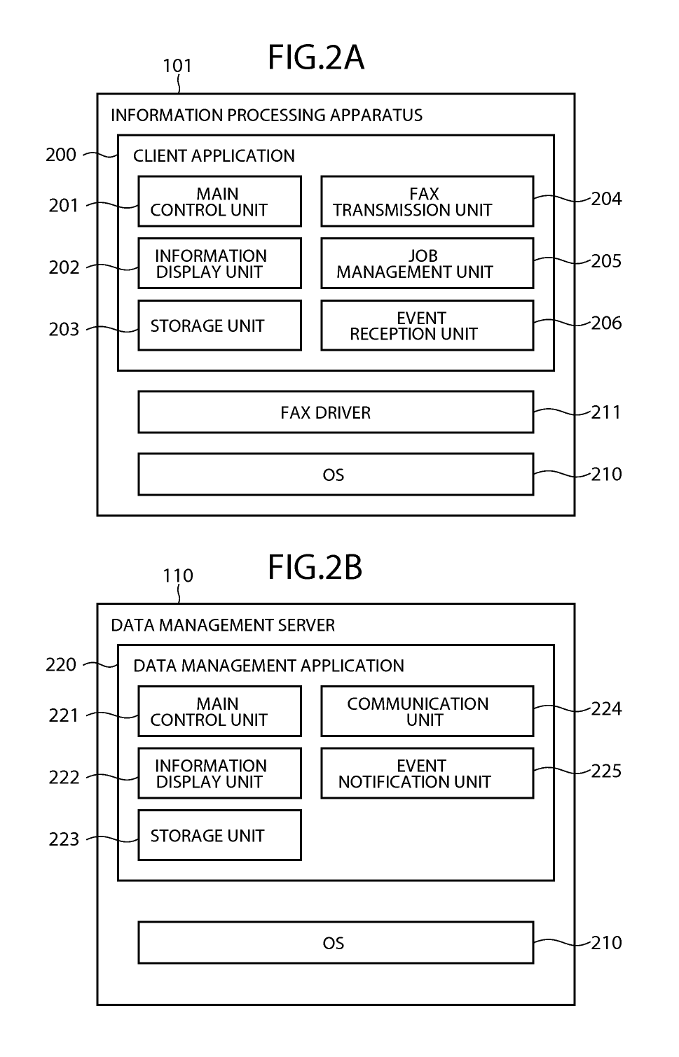

Next, a software configuration of the information processing apparatus 101 will be described with reference to FIG. 2A. FIG. 2A is a block diagram illustrating an example of the software configuration of the information processing apparatus 101. A software configuration of the data management server 110 will be described with reference to FIG. 2B. FIG. 2B is a block diagram illustrating an example of the software configuration of the data management server 110.

An operating system (OS) 210 is described. The OS 210 provides known general OS functions (memory management, resource management, application management, and the like). A FAX driver 211 is one application installed in the OS 210. An interface (IF) used by a client application 200 to control a function of the FAX driver 211 is provided as a software development kit (SDK) for the FAX driver 211. Thus, cooperation between the client application 200 and the FAX driver 211 is ensured. For example, the cooperation herein means that client application 200 and the FAX driver 211 provide their functions to execute processing through transmitting and receiving data and instructions to and from each other. The client application 200 can control communications with the FAX driver 211 through the IF, and can use the function of the FAX driver 211 through the OS 210. The FAX driver 211 executes processing in accordance with an instruction from the client application 200 through the SDK or the OS 210. Upon receiving a FAX transmission instruction from the client application 200, the FAX driver 211 converts a document file designated by an output instruction into FAX transmission data format (raster data, for example) that can be interpreted by the image forming apparatus 111. Then, the FAX driver 211 transmits the resultant data to the image forming apparatus 111 through the network.

### [Software Configuration (Client Application)]

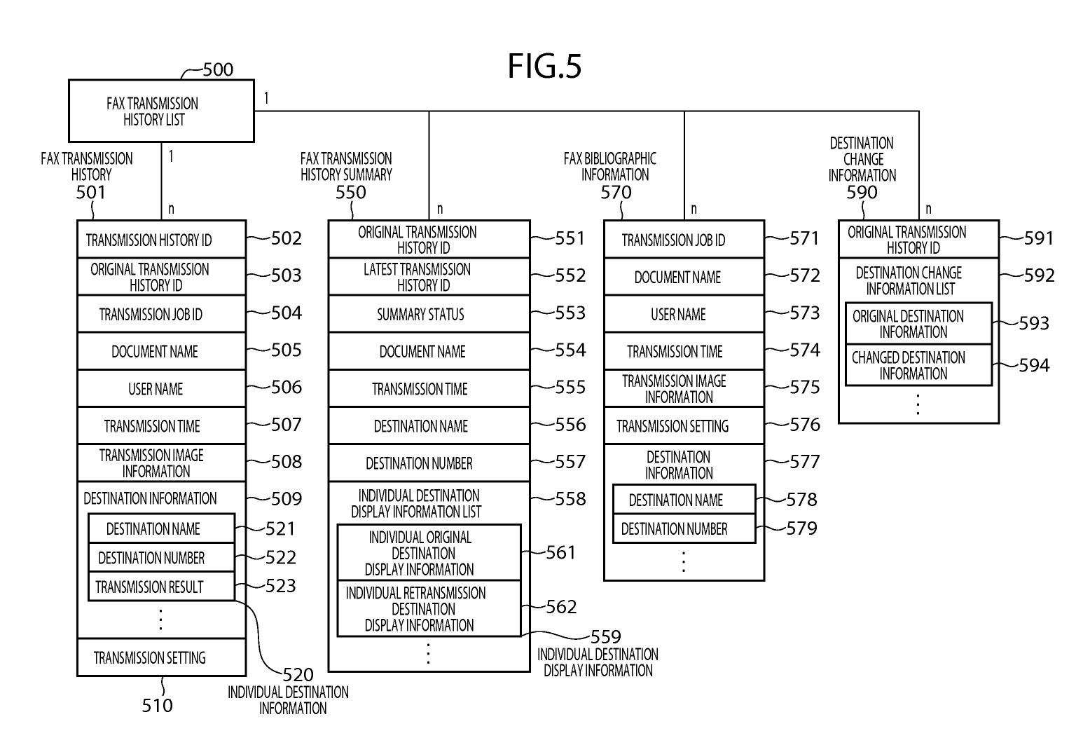

A software configuration of the client application 200 implemented by the information processing apparatus 101 is described below in detail with reference to FIG. 2A. The client application 200 includes various modules (201 to 205). A main control unit 201 controls the client application 200 and issues an instruction to each module units to be managed as described below. An information display unit 202 provides a user interface (UI) of the client application 200 to a user, in accordance with an instruction from the main control unit 201. A storage unit 203 stores and manages various types of data of the client application 200. A FAX transmission unit 204 instructs the FAX driver 211 to execute FAX transmission. A job management unit 205 acquires an image file for FAX transmission stored in the FAX driver 211, FAX bibliographic information 570 illustrated in FIG. 5 described below, and a state of a FAX transmission job in the image forming apparatus 111. An event reception unit receives Add/Change event from an event notification unit 225 of the data management server 110, when a FAX transmission history is added/changed by the data management server 110. The FAX transmission job is one example of an output job.

### [Software Configuration (Data Management Application)]

A software configuration of a data management application 220 implemented by the data management server 102 is described in detail below with reference to FIG. 2B. The data management application 220 includes various modules (221 to 225). A main control unit 221 controls the data management application 220, and issues an instruction to the module units to be managed as described below. An information display unit 222 provides a UI of the data management application 220 to the user in accordance with the instruction from the main control unit 221. A storage unit 223 stores and manages various types of data of the data management application 220. A communication unit 224 communicates with the information processing apparatus 101 so that information is transmitted and received therebetween under a predetermined protocol. An event notification unit 225 notifies the information processing apparatus 101 of an event when the FAX transmission history is added/changed.

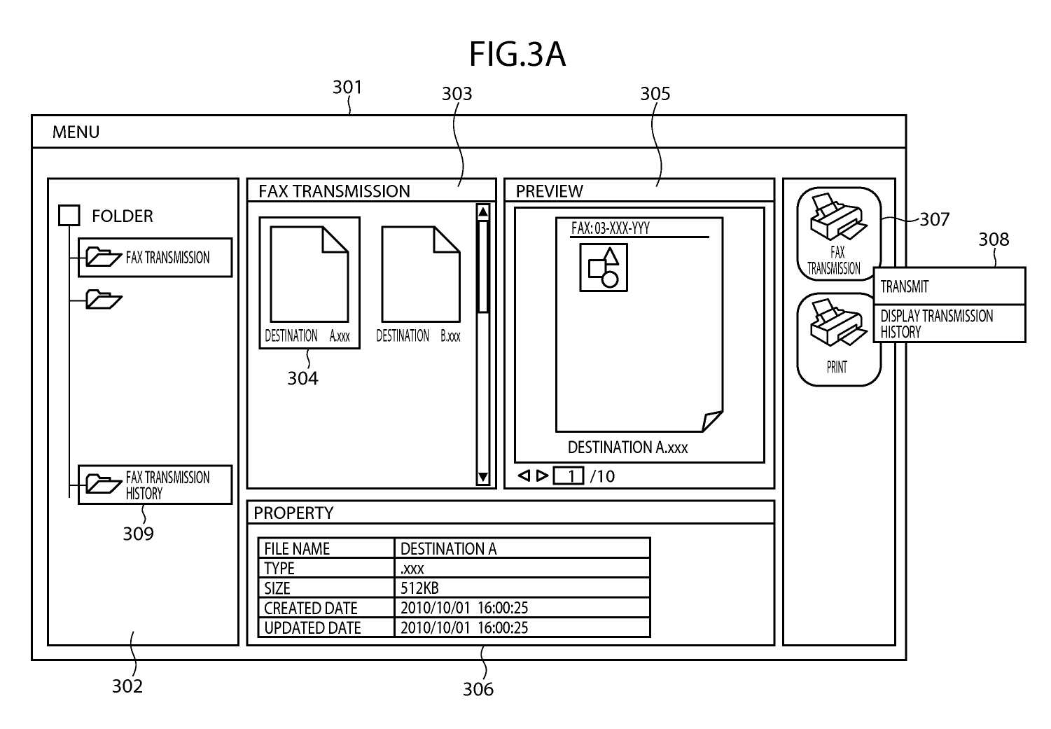

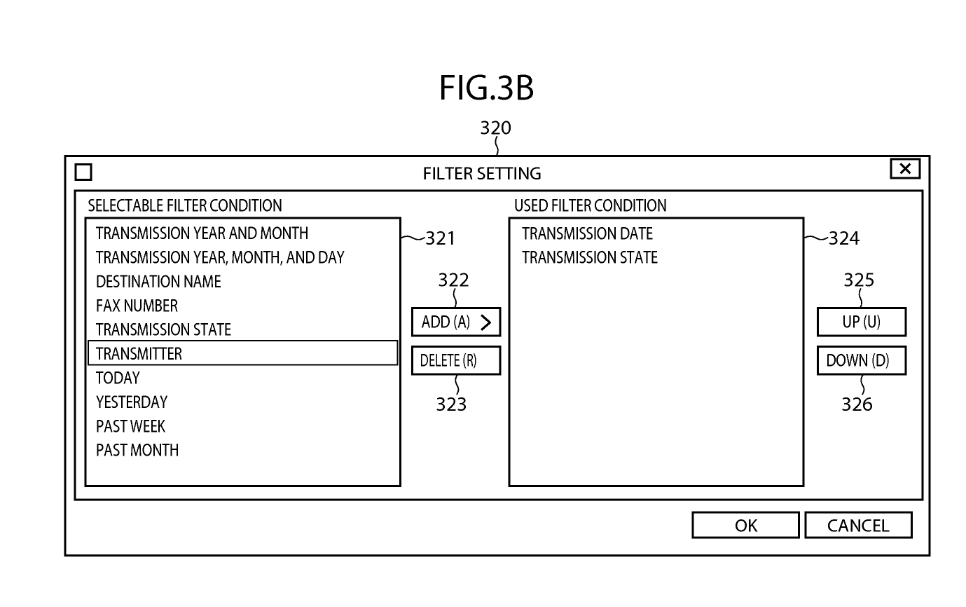

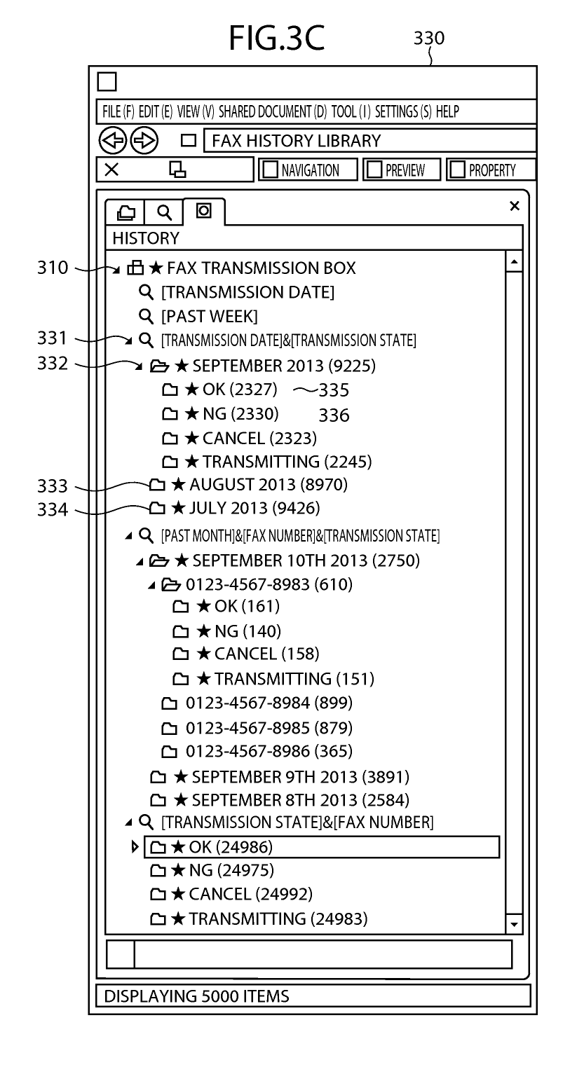

FIG. 3A is a diagram illustrating an example of a UI of the client application 200.

A main UI 301 includes a folder tree view 302 for managing files at different folder hierarchical levels. The main UI 301 further includes a file view 303 on which a files in a folder is displayed. In FIG. 3A, the folder tree view 302 includes a FAX transmission folder currently being selected by the user. Files in the selected folder are displayed on the file view 303. The display on the file view 303 indicates that the FAX transmission folder includes destination A.xxx and destination B.xxx files. A file 304 is a file currently being selected in the file view 303. On a preview 305, a preview of the selected file 304 can be given. A file property 306 displays information on the selected file 304. The information displayed on the file property 306 is managed by a file management application. The information displayed on the file property 306, which is the information on the file 304, includes a file name, a type, a file size, a creation date, and an update date for example.

The main UI 301 further includes a search-base-folder tree view 309. A filter condition (filtering condition or search condition) for FAX transmission history data set by the user is assigned to each folder in the folder tree view 309. More specifically, each folder, displayed when the folder tree view 309 is expanded, is associated with the filter condition. When the user expands the folder tree view 309, a search is executed, and the name of the FAX transmission history matching with the filter condition of each folder and the total number of search results are displayed as a suffix of the folder name. The user can search through the folder hierarchical levels to display a search result matching with a detail filter condition.

FIG. 3B is a diagram illustrating an example of a filter setting UI 320.

The filter setting UI 320 is a UI used by the user to set a filter condition to be associated with a folder. When the filter condition is set through the filter setting UI 320, a folder associated with the filter condition is added to the folder tree view 309. In a selectable filter condition 321, filter condition items that can be set by the user are listed. The user can add or delete the filter condition by selecting an item in the selectable filter condition 321, and by selecting (or pressing) an add button 322 or a delete button 323. The selected filter condition is added to a used filter condition 324. A plurality of filter conditions can be registered. A plurality of filter conditions is respectively associated with folder hierarchical levels and with filter conditions in the registered order. An up button 325 and a down button 326 are buttons for changing the registered order. In sum, the CPU 102 adds a folder associated with a filter condition, in accordance with a setting operation executed by the user through the filter setting UI 320.

FIG. 3C is a diagram illustrating in detail a window 330 that is displayed when the folder tree view 309, to which a filter condition is set, is expanded. For example, in a case where folder hierarchical levels are displayed with a filter condition, as a result of registering “transmission date” and “transmission state” in the used filter condition 324 as illustrated in FIG. 3B set, when a folder 331 associated with the filter condition including “transmission date” and “transmission state” is expanded, FAX transmission history data is filtered (searched) by “transmission date”. The result (search result) is displayed in association with a folder. A folder 332 indicates that FAX transmission histories matching with September 2013 as the transmission year and month have been searched and that 9225 pieces of FAX transmission histories matching with the condition have been found. A folder 333 indicates that FAX transmission histories matching with August 2013 as the transmission year and month have been searched and that 8970 pieces of FAX transmission histories matching with the condition have been found. A folder 334 indicates that FAX transmission histories matching with July 2013 as the transmission year and month have been searched and that 9426 pieces of FAX transmission histories matching with the condition have been found. A folder 335 which is displayed when the folder 332 is expanded, has a suffix indicating that FAX transmission histories matching with September 2013 as the transmission year and month and “OK (transmission successful)” as the transmission result have been searched, and that 2327 pieces of FAX transmission histories matching with the conditions have been found. A folder 336 indicates that FAX transmission histories matching with September 2013 as the transmission year and month and “NG (transmission failed)” as the transmission result have been searched, and that 2330 pieces of FAX transmission histories matching with the conditions have been found.

Referring back to FIG. 3A, a FAX transmission button 307 is one function of the client application 200. FAX transmission processing is executed when the FAX transmission button 307 is pressed while a file is in a selected state. Alternatively, the FAX transmission processing may be executed when a file is dragged and dropped onto the FAX transmission button 307. In FIG. 3A, the file 304 is selected. Thus, when the FAX transmission button 307 is pressed, the FAX transmission for the file 304 is executed. A context menu 308 is a menu in which available operations are displayed when a mouse cursor points at the FAX transmission button 307. In the present exemplary embodiment, the context menu 308 of the FAX transmission button 307 includes “FAX transmission” and “display transmission history”.

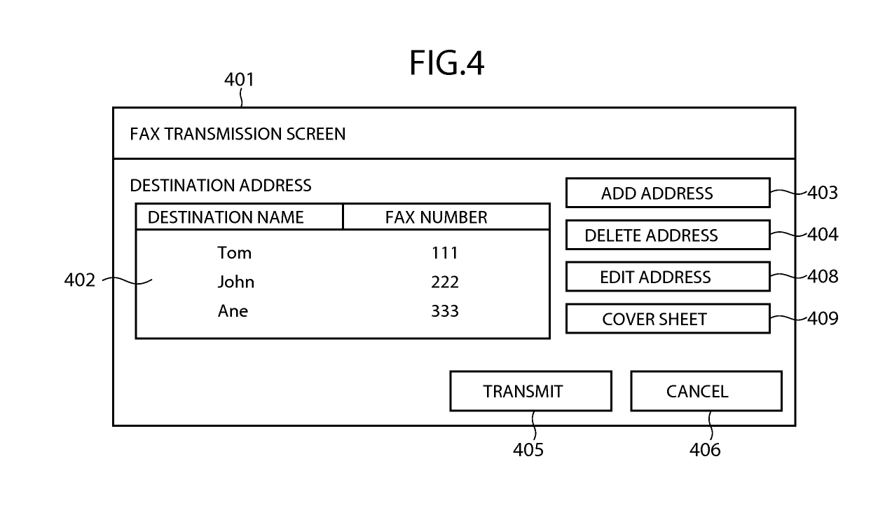

FIG. 4 is a diagram illustrating an example of a FAX transmission UI 401 of the client application 200. The FAX transmission UI 401 in FIG. 4 is displayed when the user drops a file onto the FAX transmission button 307 or selects “FAX transmission” in the context menu 308. The FAX transmission UI 401 in FIG. 4 is also displayed in a FAX transmission flow described below.

The FAX transmission UI 401 is a UI which is displayed when executing FAX transmission for the selected file 304. In the FAX transmission UI 401, a destination address 402 designated by the user is displayed. The destination address 402 is information used as a setting value at the time of the FAX transmission. In the destination address 402, a destination number and a destination name of the FAX is displayed. The setting value at the time of the FAX transmission may further include the type of a FAX line and the like. The client application 200 can display a plurality of destination information pieces when multi-address transmission is executed to transmit a single file to a plurality of destinations. An add address button 403 is a button for adding new FAX destination information to the destination address 402. When the add address button 403 is pressed, a destination add UI is displayed, on which the user can input destination information to be added to the destination address 402.

A delete address button 404 is a button for deleting destination information added to the destination address 402. A transmit FAX button 405 is a button for executing FAX transmission to a destination added to the destination address 402. The FAX transmission is executed when the transmit FAX button 405 is pressed. A FAX transmission instruction from a file management application is executed by the FAX driver 211 through the OS 210. A cancel button 406 is a button for cancelling the execution of the FAX transmission. When the cancel button 406 is pressed, the client application 200 closes the FAX transmission UI 401. An edit address button 408 is a button used for editing destination information added to the destination address 402. When the edit address button 408 is pressed, an address edit UI is displayed. In the UI, the user can edit the destination information selected in the destination address 402.

### [Data Structure (FAX Transmission History List 500)]

FIG. 5 is a diagram schematically illustrating an example of FAX transmission history data. A FAX transmission history list 500 includes at least one FAX transmission history 501, at least one FAX transmission history summary 550, at least one piece of FAX bibliographic information 570, and at least one piece of destination change information 590. The FAX transmission history list 500 is stored as a file in the storage unit 223 of the data management server 110. Alternatively, the FAX transmission history list 500 may be managed in a database of the data management server 110.

The FAX transmission history 501 stores content and a result of the FAX transmission. A transmission history ID is an ID for identifying a FAX transmission history uniquely provided for each FAX transmission executed by the user. An original transmission history ID 503 stores a transmission history ID of a retransmission source. A transmission job ID 504 is notified to the FAX driver 211 at the time of the FAX transmission, and serves to associate the FAX transmission history 501 and the FAX bibliographic information 570 created by the FAX driver 211 with each other. A document name 505 is a name of a document used in the FAX transmission. A user name 506 is a name of a user who has transmitted a FAX. A transmission time 507 is a date and time of the FAX transmission. Transmission image information 508 is information for referring to an image transmitted by the FAX transmission. More specifically, the transmission image information 508 includes at least a reference file path to an image file transmitted by the FAX transmission. Destination information 509 includes at least one piece of individual destination information 520. The individual destination information 520 includes a destination name 521, a destination number 522, and a transmission result 523. The destination name 521 is the name of a destination of the FAX transmission. The destination number 522 is a FAX number. The transmission result 523 is a result of the FAX transmission. The transmission result 523 includes an “in-process” status indicating that the FAX transmission is in process, a “transmission successful” status indicating that the FAX transmission has succeeded, and a “transmission failed” status indicating that the FAX transmission has failed. The transmission result 523 further includes a “cancel” status and an “unknown” status. The “cancel” status indicates that the user has canceled the FAX transmission job at the image forming apparatus 111 while the FAX transmission is in process. The “unknown” status indicates that the transmission job ID is unmatched. A transmission setting 510 stores settings used for the FAX transmission that include whether there is a cover sheet, for example.

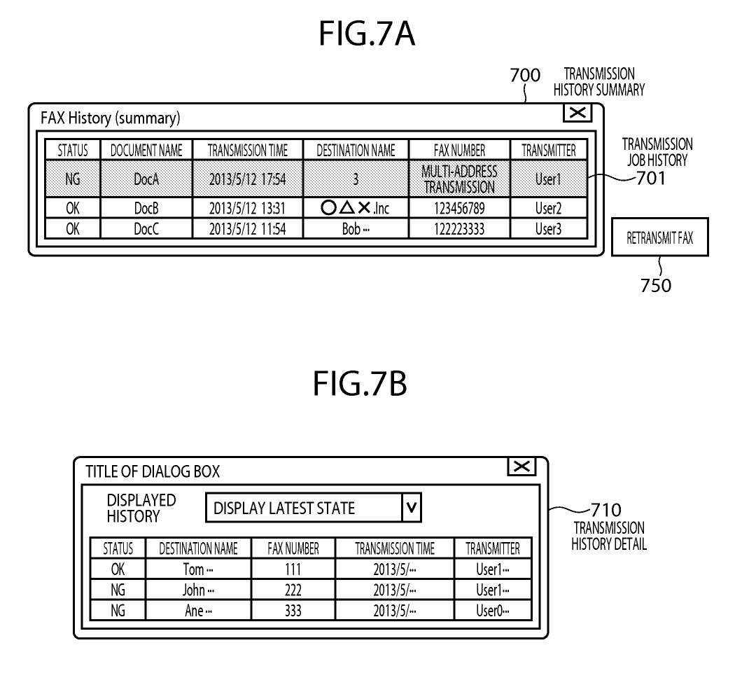

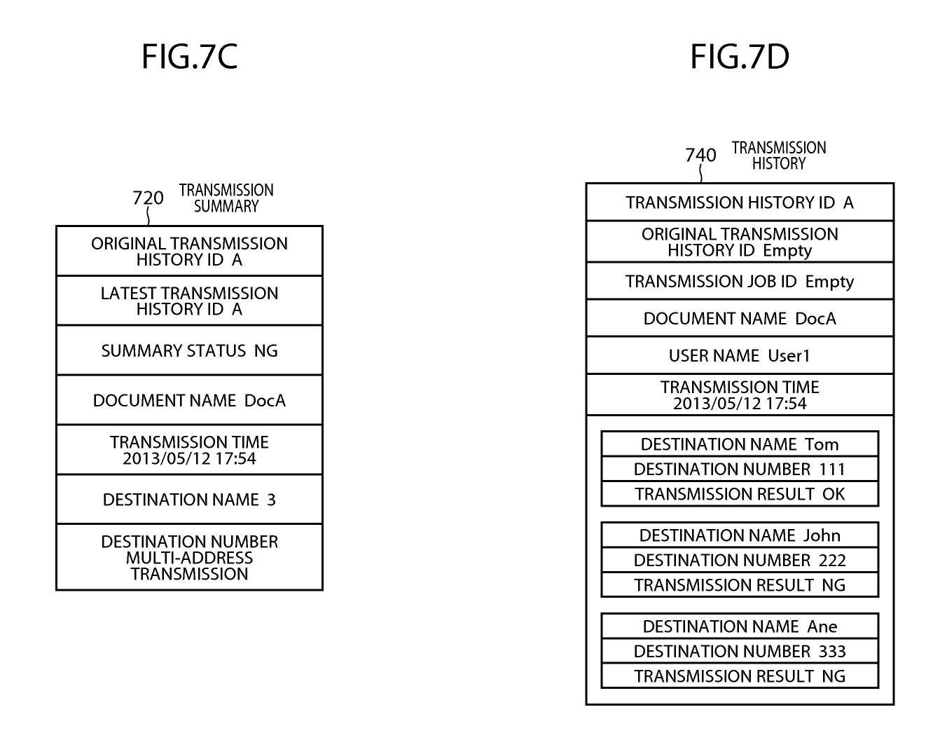

The FAX transmission history summary 550 stores data obtained by compiling FAX transmission histories having the same original transmission history ID. More specifically, the FAX transmission history summary 550 is data obtained by compiling a FAX transmission history created for retransmission and a transmission history used for the retransmission. The FAX transmission history summary 550 is data for displaying a transmission history summary 700 described below with reference to FIGS. 7A, 7B, 7C, and 7D. The FAX transmission history summary 550 can be created from the FAX transmission history 501 and a destination change information 590, and thus may at least partially or all be stored as a file or retained in the RAM. An original transmission history ID 551 stores the transmission history ID as a retransmission source. A latest transmission history ID 552 stores a transmission history ID of a FAX transmission history of the latest transmission executed using the FAX transmission history as the retransmission source. A summary status 553 is a transmission result obtained by compiling the FAX transmission history created by the retransmission and the transmission history used for the retransmission. A document name 554 is the same as the document name 505. A transmission time 555 is a transmission time of the latest FAX transmission executed using the FAX transmission history as the retransmission source. A destination name 556 is a name of the FAX destination of the FAX transmission executed using the FAX transmission history as the retransmission source. When there is a plurality of destinations, the destination name 556 stores information indicating that there is a plurality of destinations. For example, when there are three destinations, the destination name 556 stores information “3”. A destination number 557 is a FAX number of the FAX transmission destination. When there is a plurality of destinations, the destination number 557 stores information indicating that there is a plurality of destinations. For example, the destination number 557 stores information “multi-address transmission”. An individual display information list 558 includes at least one piece of individual display information 559. The individual display information 559 includes individual original destination display information 561 and individual retransmission destination display information 562. The individual original destination display information 561 is information related to a destination and display in the first transmission. The individual retransmission destination display information 562 is information related to at least one destination and display in retransmission. The individual original destination display information 561 and the individual retransmission destination display information 562 store at least information on a destination name, a destination number, and a transmission result. The individual original destination display information 561 and the individual retransmission destination display information 562 may further store a transmission time, a transmission user, and the like.

The FAX bibliographic information 570 is information related to content of the transmitted FAX and is created by the FAX driver 211 at the time of the FAX transmission. A transmission job ID 571 is an ID for identifying a FAX transmission job. When a transmission job ID is notified from the client application 200, the transmission job ID 571 stores the notified ID. When a transmission job ID is not notified from the client application 200, the FAX driver 211 creates an ID and the transmission job ID 571 stores the created ID. A document name 572 is the name of a document used for the FAX transmission. A user name 573 is the name of a user who transmitted a FAX. A transmission time 574 is a date and time of the FAX transmission. Transmission image information 575 is information for referring to an image transmitted by the FAX transmission. More specifically, the transmission image information 575 includes at least a reference file path to an image file transmitted by the FAX transmission. A transmission setting 576 stores settings used for the FAX transmission that indicates whether there is a cover sheet for example. Destination information 577 includes a pair of a destination name 578 and a destination number 579 to which the FAX transmission has been executed.

When the destination is changed at the time of the FAX retransmission, the destination change information 590 stores information related to the destinations before and after the change. An original transmission history 591 stores a transmission history ID as a retransmission source. A destination information list 592 stores at least one piece of original destination information 593 and one piece of changed destination information 594. The original destination information 593 stores individual destination information 520 as the retransmission source at the time of retransmission. The changed destination information 594 stores the individual destination information 520 of the FAX transmission history 501 at the time of retransmission.

### [FAX Transmission Flow]

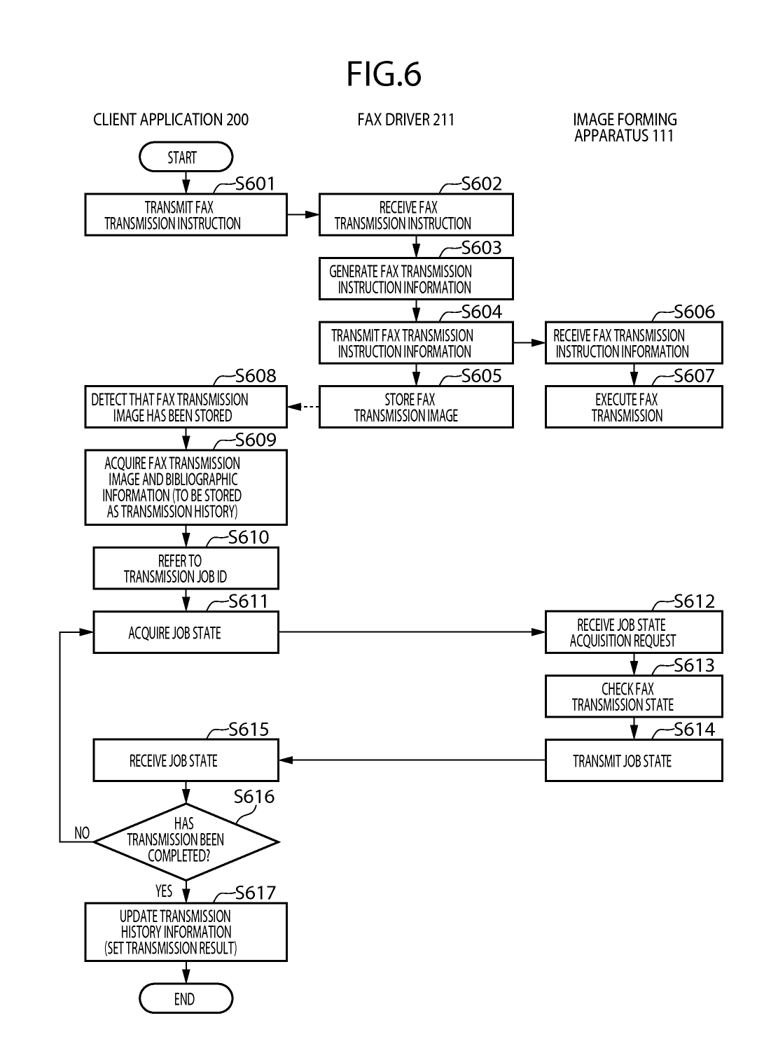

FAX transmission processing in the client application 200 of the information processing apparatus 101 is described with reference to FIG. 6.

FIG. 6 is a flowchart related to processing from execution of the FAX transmission in the client application 200 to acquisition of a FAX transmission image and FAX bibliographic information created by the FAX driver 211 and a transmission result in the image forming apparatus 111 and to storing of the image and the information as a FAX transmission history. For example, the FAX transmission in the client application 200 is triggered by a FAX transmission operation executed by the user through selecting a file on the file view 303 and pressing the FAX transmission button 307, as described above.

Upon receiving the transmission instruction from the user, in step S601, the main control unit 201 executes the following processing. Specifically, the main control unit 201 instructs the FAX driver 211 to execute the FAX transmission through the FAX transmission unit 204. Transmission instruction information used in this process is a file being selected on the file view 303 and a transmission setting designated on the FAX transmission UI 401, which can be acquired through an instruction from the main control unit 201 to the information display unit 202.

In step S602, the FAX driver 211 receives the FAX transmission instruction from the client application 200.

Then, in step S603, the FAX driver 211 creates FAX transmission instruction information for causing the image forming apparatus 111 to execute the FAX transmission, based on the received transmission instruction information. More specifically, the FAX driver 211 converts a file designated as a file to be transmitted by the FAX transmission into data such as raster data that can be processed in the image forming apparatus 111. Then, the FAX driver 211 generates the FAX transmission instruction information as a transmission instruction that can be interpreted and executed in the image forming apparatus 111.

In step S604, the FAX driver 211 transmits the FAX transmission instruction information generated in step S603 to the image forming apparatus 111 through the network.

In step S605, the FAX driver 211 stores a FAX transmission image transmitted to the image forming apparatus 111. More specifically, the FAX driver 211 stores the image data obtained by the data conversion as a file in a general image storage format such as tagged image file format (TIFF). The FAX driver 211 stores the transmission instruction information as the FAX bibliographic information 570. The FAX bibliographic information 570 is stored in a structured text file format such as extensible markup language (XML).

In step S606, the image forming apparatus 111 receives the FAX transmission instruction. Then, in step S607, the image forming apparatus 111 executes the FAX transmission by transmitting an image to another FAX apparatus and an IP-FAX through a public line or the Internet, based on the received FAX transmission instruction information.

In step S608, the client application 200 detects that the FAX transmission image has been stored by the FAX driver 211. The storing of the FAX transmission image can be detected as follows. The job management unit 205 of the client application 200 receives the notification indicating that the storing of the FAX transmission image has been completed from the FAX driver 211. Alternatively, the job management unit 205 may monitor file creation in a storage destination of the FAX transmission image of the FAX driver 211 to perform the detection. Upon detecting that the FAX transmission image has been stored, the job management unit 205 notifies the main control unit 201 of the detection.

In step S609, the main control unit 201 of the client application 200 acquires the FAX bibliographic information 570 and the FAX transmission image detected in step S608. More specifically, the main control unit 201 copies the files of the FAX transmission image and the FAX bibliographic information 570 to a predetermined memory managed in the client application 200. Then, the main control unit 201 reads the FAX bibliographic information 570, generates the FAX transmission history 501, and instructs the storage unit 203 to store the FAX transmission history 501. The FAX transmission history 501 is stored in the data management server 110 and can be shared by a plurality of users to view or retransmit. When the FAX transmission history 501 is stored, the data management server 110 causes the event notification unit 225 to notify the information processing apparatus 101 displaying the folder tree view 309 , through an event, that the FAX transmission history 501 is newly added. Here, the event type is the Add event, and the transmission result of the FAX transmission history 501 is the “in-process” status. Upon receiving the event through the event reception unit 206, the information processing apparatus 101 displaying the folder tree view 309 executes a tree display flow described below.

In step S610, the main control unit 201 refers to a transmission job ID defined in the FAX bibliographic information 570 read in step S609. The transmission job ID is an ID for uniquely identifying a transmission instruction (FAX transmission job) executed by the FAX driver 211. The main control unit 201 makes an inquiry to the image forming apparatus 111 by using the transmission job ID as a key, and thus can acquire information on the FAX transmission job that corresponds to the key.

In step S611, the main control unit 201 instructs the job management unit 205 to designate the transmission job ID referred to in step S610 and transmit an acquisition request for a state of the FAX transmission job to the image forming apparatus 111.

In step S612, the image forming apparatus 111 receives the acquisition request for the state of the FAX transmission job from the client application 200. In step S613, the image forming apparatus 111 checks the state of the FAX transmission job corresponding to the designated transmission job ID. The state of the FAX transmission job includes an in-process state and a finished state. The in-process state includes a state where image data is in a process of rasterizing, a state of calling the destination, and the like. The finished state of the completed job includes successful transmission, failed transmission, and the like. The image forming apparatus 111 checks the state of the FAX transmission job by referring to a processing state on a memory of the image forming apparatus 111 and FAX transmission log information stored in the HDD. In step S614, the image forming apparatus 111 transmits the state of the FAX transmission job checked in step S613, to the information processing apparatus 101 that has made the request.

In step S615, the job management unit 205 receives the job state as the response from the image forming apparatus 111, and notifies the main control unit 201 of the state.

In step S616, the main control unit 201 checks the job state thus received, and determines whether the job state is the finished state. When the job state is the in-process state (No in step S616), the processing returns to step S611 after a predetermined period of time, and thus the main control unit 201 issues the job state request to the image forming apparatus 111 again. When the main control unit 201 determines that the job state is the finished state (Yes in step S616), the processing proceeds to step S617. In step S616, the main control unit 201 determines that the job state is the finished state even when a job state indicating a transmission failure is received as a result of retrying the FAX transmission for predetermined times.

In Step S617, the main control unit 201 instructs storage unit 203 to store the finished state of the transmission result in the FAX transmission history 501. When the transmission result in the FAX transmission history 501 is thus changed, the data management server 110 causes the event notification unit 225 to notify the information processing apparatus 101 displaying the folder tree view 309, through an event, that the FAX transmission history 501 has been changed. Here, the type of the event is the Change event. The transmission result in the FAX transmission history 501 is the “transmission successful” status when the job has been successfully transmitted, and is the “transmission failed” status when the transmission of the job has failed. Upon receiving the event through the event reception unit 206, the information processing apparatus 101 displaying the folder tree view 309 executes the tree display flow described below.

### [Display Example of FAX Transmission History]

FIGS. 7A, 7B, 7C, and 7D are diagrams illustrating examples of a UI for displaying a FAX transmission history list and content of related data. The transmission history summary 700 is displayed when the context menu 308 is pressed. On a transmission job history 701, content and a state of the FAX transmission displayed for each transmission processing executed by the user, are displayed. The multi-address transmission and the like are displayed as a single transmission job history. In FIGS. 7A, 7B, 7C, and 7D, a transmission state (state), a document name, a transmission time, a destination name, a fax number, and a transmitter are displayed as the transmission job history 701. The transmission job history 701 is displayed based on a transmission summary 720 as one example of the FAX transmission history summary 550. For example, a state of the transmission history summary 700 is displayed based on a summary status of the transmission summary 720. Here, NG is displayed based on the “transmission failed” status indicating that the transmission has failed.

When a context menu 750 is pressed, FAX retransmission processing using the transmission job history 701 is executed.

A transmission history detail 710 is an example of a UI for displaying a transmission state and transmission content for each destination of the transmission job history 701. In the UI, the latest transmission state and transmission content for each destination are displayed. The transmission history detail 710 is displayed based on a transmission history 740. For example, in the transmission history detail 710, a state of Tom as the destination name is displayed as “OK” based on the transmission result “transmission successful” indicating that the transmission to Tom as the destination name has succeeded.

### [Tree Display Flow]

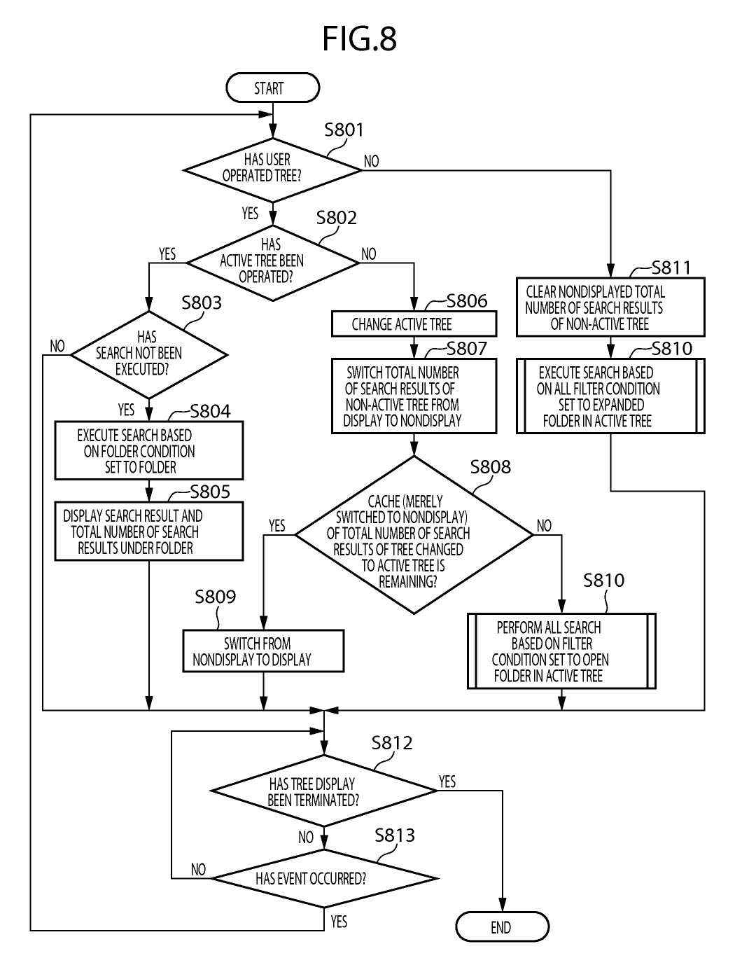

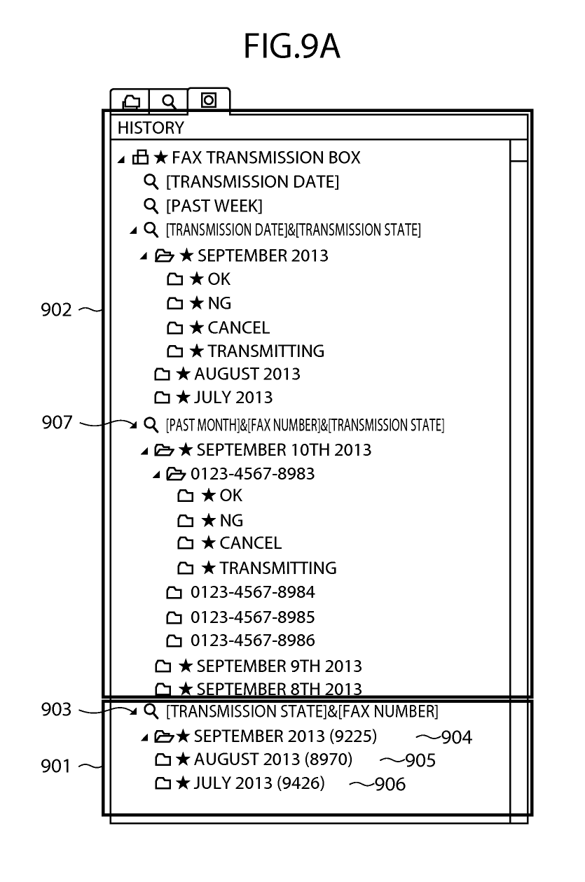

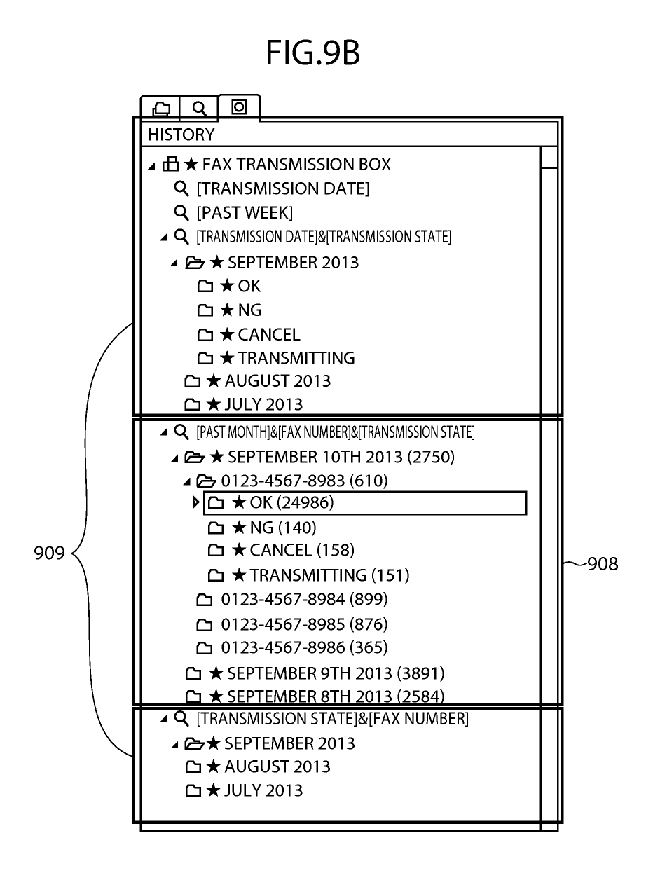

Tree display control processing in the client application 200 of the information processing apparatus 101 is described with reference to a flowchart in FIG. 8 and FIGS. 9A and 9B. FIG. 8 is a flowchart related to the tree display processing for the folder tree view 309 in the main UI 301 of the client application 200.

In step S801, the client application 200 determines whether the user has operated the folder tree view 309 in the main UI 301, or the event reception unit 206 has received an event. When the user has operated the folder tree view 309 (Yes in step S801), the processing proceeds to step S802. When the event reception unit 206 has received the Add event or the Change event due to the FAX history change in the data management server 110 (No in step S801), the processing proceeds to step S811.

In step S802, the client application 200 determines whether the user operation has been made on an active tree. The active tree is a tree selected by the user from a group of trees having root node as a node to which the user has set a filter. A tree not selected by the user is referred to as a non-active tree. A folder selected by the user may be referred to as an active folder, and a folder not selected by the user may be referred to as a non-active folder. For example, when a folder 903 in FIG. 9A is selected, a tree 901 under the folder 903 is selected as the active tree. Here a tree 902 is an example of a group of non-active trees. When the user operates a certain folder in the tree 901, the client application 200 determines that the operation has been made on the active tree.

The processing proceeds to step S803 when the client application 200 determines that the user operation has been made on the active tree (Yes in step S802), and proceeds to step S812 when the client application 200 determines that the user operation has been made on the non-active tree (No in step S802).

In step S803, the client application 200 determines whether a search with a filter condition associated with the operated folder has been executed. The processing proceeds to step S804 when the search has not been executed (Yes in step S804). The processing proceeds to step S812 when the search has been executed, or when the folder has not been associated with any filter condition (No in step S803). The folder that has not been associated with any filter condition (with no filter condition set) is a folder at a third hierarchical level in a case where two filter conditions have been associated.

In step S804, the client application 200 executes a search based on the filter condition associated with the operated folder. In step S805, the client application 200 displays the search result and the total number of search results under (in association with) the folder, based on the result of the search executed in step S804. For example, a case is described where the folder 903 is selected. The folder 903 is associated with a filter condition obtained by registering “transmission year and month” and “transmission state” in the filter condition 324 to be used, in this order as illustrated in FIG. 3B. A search is executed on the FAX transmission history data with the filter condition “transmission year and month”. As the result of the search, the client application 200 displays information indicating that the folder 904 has 9225 pieces of FAX transmission histories having September 2013 as “transmission year and month”, the folder 905 has 8970 pieces of FAX transmission histories having August 2013 as “transmission year and month”, and the folder 906 has 9426 pieces of FAX transmission histories having July 2013 as “transmission year and month”.

In step S806, the client application 200 changes the active tree to a newly selected tree.

In step S807, the client application 200 switches display of the folder about the total number of search results of the non-active tree which has been changed from the active tree, from a display state to a nondisplay state. For example, when a folder 907 is switched to a selected state from a state where the folder 903 is being selected, a tree 909 (a portion in the trees 901 and 902 except for the tree 907) and a tree 908 that are illustrated in FIG. 9B are respectively switched to the non-active tree and the active tree.

In step S808, the client application 200 determines whether a cache of the total number of search results (that has been switched from the display state to the nondisplay state) is remaining in each folder in the active tree that has been switched from the non-active tree. The processing proceeds to step S809, when the cache is remaining (Yes in step S808). The processing proceeds to step S810 when the cache is not remaining in the folder (No in step S808).

In step S809, the client application 200 displays the cache.

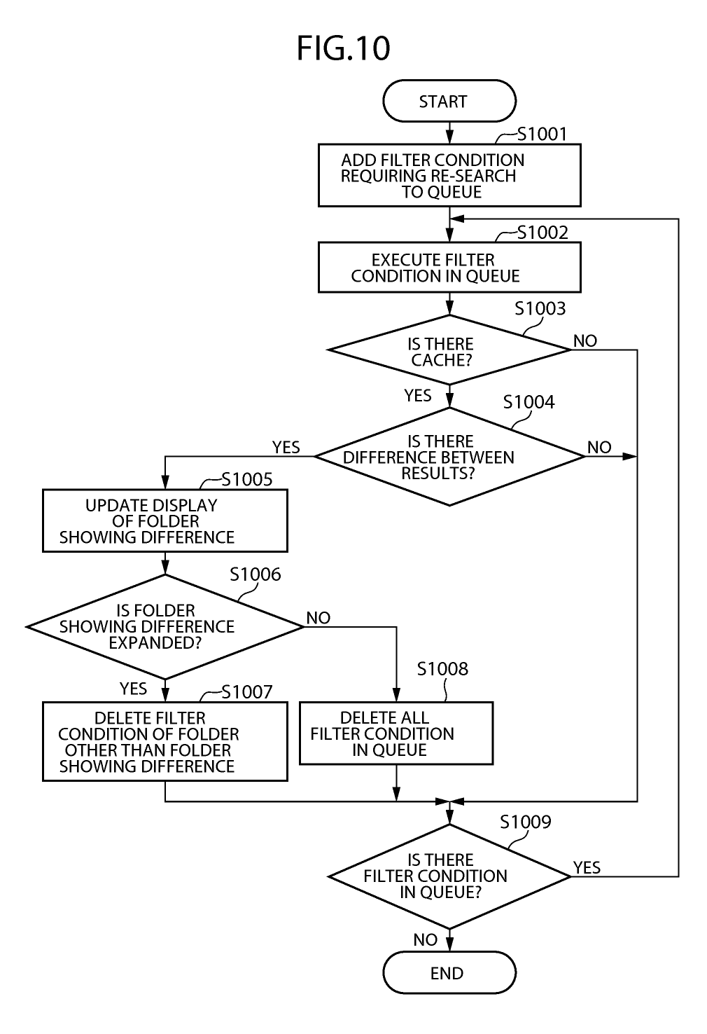

In step S810, the client application 200 executes all searches based on the filter conditions associated with the folders expanded in the current active tree. The processing in step S810 will be described in detail below with reference to FIG. 10.

In step S811, the client application 200 clears the total number of search results of the non-active tree in the nondisplay state.

In step S812, the client application 200 determines whether the user has terminated the tree display by terminating the application. The processing illustrated in FIG. 8 is terminated when the user has terminated the display (Yes in step S812).

In step S813, the client application 200 determines whether the user operation on the folder tree view 309 has been detected or the event reception unit 206 has newly received an event. The processing proceeds to step S801 when the operation has been detected or the event has been received (Yes in step S813), and returns to step S812 when determined otherwise (No in step S813).

As described above, the client application 200 switches the number of search results between the display state and the nondisplay state according to whether a tree is the active tree or the non-active tree. More specifically, control is executed in such a manner that the search is executed for folders in the active tree and not for those in the non-active tree, whereby the number of re-searching due to an occurrence of an event can be reduced. Furthermore, the client application 200 does not execute the re-search for the non-active tree until the non-active tree is selected by the user, whereby the number of re-searching can be minimized.

### [Search Flow]

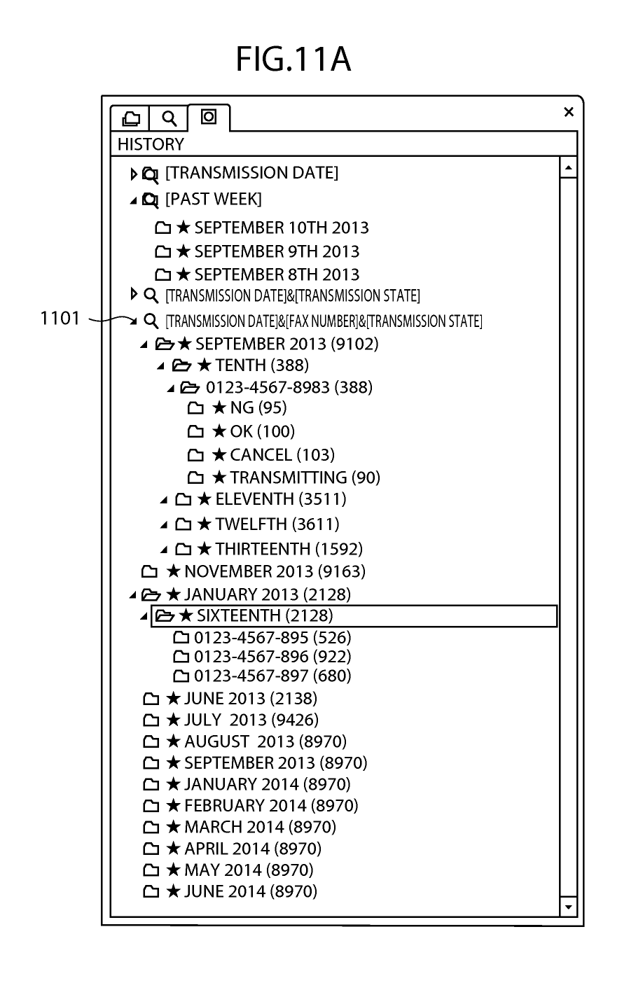

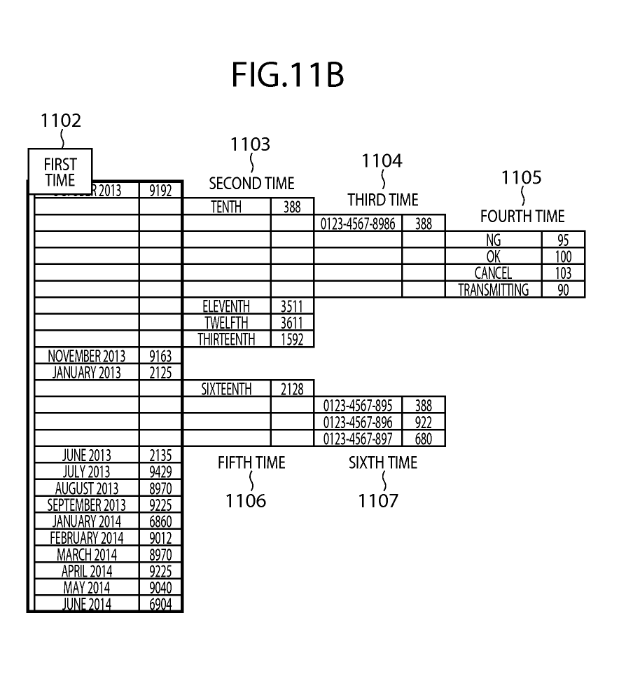

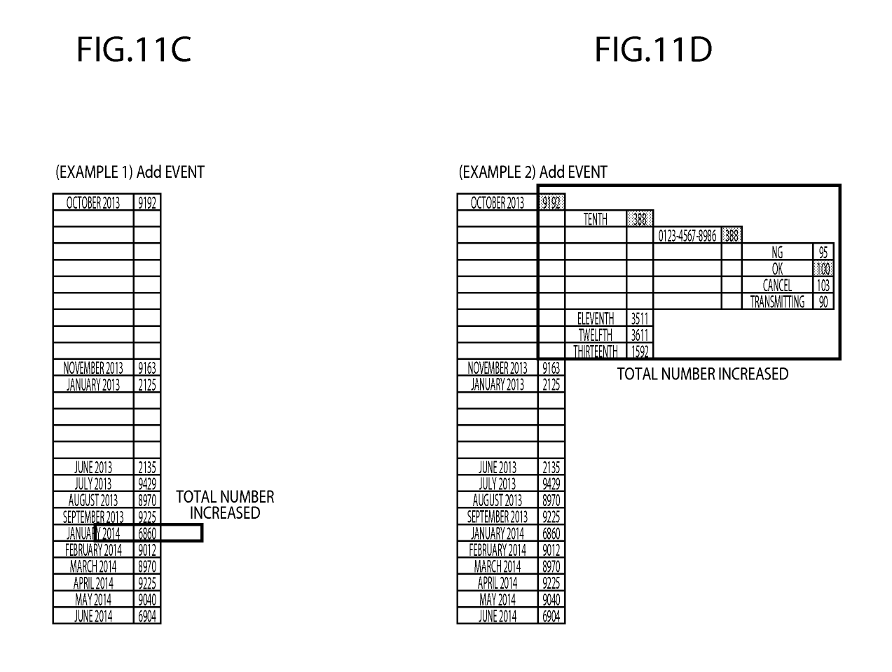

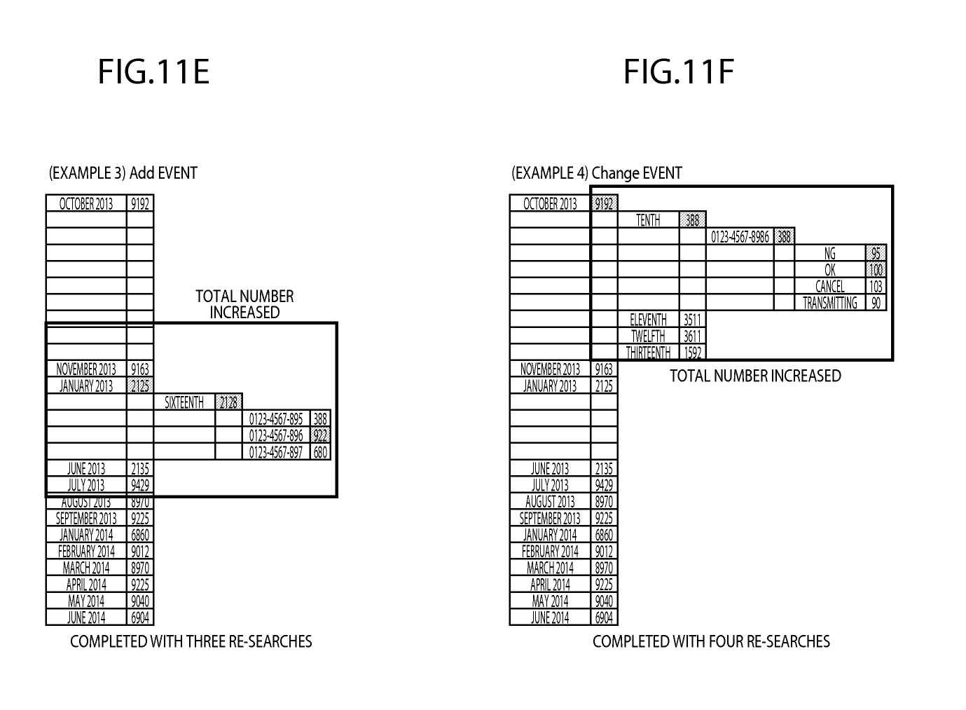

The search processing (step S810) executed by the client application 200 of the information processing apparatus 101 is described with reference to a flowchart in FIG. 10 and FIGS. 11A to 11C. FIG. 10 is a flowchart illustrating an example of the processing executed by the client application 200 in step S810.

In step S1001, the client application 200 adds to a queue a filter condition (search condition associated with each folder in the active tree) which requires a re-search.

In step S1002, the client application 200 executes a search with the first filter condition added to the queue.

In step S1003, the client application 200 determines whether there is a cache of the total number of search results in each folder. The processing proceeds to step S1004 when there is the cache (Yes in step S1003), and proceeds to step S1009 when there is no cache (No in step S1003).

In step S1004, the client application 200 determines whether there is a difference between the execution result obtained in step S1002 and the cached search result. The processing proceeds to step S1005 when there is a difference between the results (Yes in step S1004), and proceeds to step S1009 when there is no difference (No is step S1004).

In step S1005, the client application 200 updates the display content of the folder showing the difference.

In step S1006, the client application 200 determines whether the folder showing the difference is expanded. The processing proceeds to step S1007 when the folder is expanded (Yes in step S1006), and proceeds to step S1008 when the folder is not expanded (No in step S1006).

In step S1007, the client application 200 deletes the filter conditions of folders other than the folder showing the difference from the queue.

In step S1008, the client application 200 deletes all the filter conditions remaining in the queue.

In step S1009, the client application 200 determines whether there is a filter condition requiring a re-search in the queue. The processing proceeds to step S1002 when there is the filter condition (Yes in step S1009). The processing in FIG. 10 is terminated when there is no filter condition (No in step S1009).

The processing according to FIG. 10 is described with a more specific example in which a folder is expanded as illustrated in FIG. 11A with filter conditions “transmission year and month”, “fax number”, and “transmission state” set to a folder 1101. To create the display UI in which the folder is expanded as illustrated in FIG. 11B, total of six searches are executed with the following filter conditions.

A first search 1102 is executed with a filter condition “transmission year and date”.

A second search 1103 is executed with filter condition “transmission day” with October 2013 as “transmission year and month”.

A third search 1104 is executed with a filter condition “FAX number”, with October 2013 as “transmission year, and month” and with 10th as “transmission day”.

A fourth search 1105 is executed with a filter condition “transmission state”, with October 2013 as “transmission year and month”, with 10th as “transmission day”, and with 0123-4567-8986 as “FAX number”.

A fifth search 1106 is executed with a filter condition “transmission day”, with January 2013 as “transmission year and month”.

A sixth search 1107 is executed with a filter condition “FAX number”, with January 2013 as “transmission year and month”, and with 16th as “transmission day”.

In step S1001, the six filter conditions are added to the queue in the order of 1102 to 1107 from the one closest to the root of the tree.

Example (a) in FIG. 11C illustrates a case where the Add event has occurred. First, in step S1002, the client application 200 executes the search with the filter condition in 1102 in FIG. 11B. In step S1004, the client application 200 determines that January 2014 (“transmission year and month”) has been changed and thus, that there is a difference between the results. In step S1005, the client application 200 updates the displayed number of search results of the “January 2014” folder. The processing proceeds to step S1008 when the client application 200 determines that the “January 2014” folder is not expanded in step S1006. In step S1008, the client application 200 deletes all the filter conditions in the queue, and thus the processing illustrated in FIG. 10 is terminated. As a result, the processing is completed with one re-search.

Example (b) in FIG. 11D illustrates a case where the Add event has occurred. First, in step S1002, the client application 200 executes the search with the filter condition in 1102 in FIG. 11B. In step S1004, the client application 200 determines that October 2013 (“transmission year and month”) has been changed and thus, that there is a difference between the results. In step S1005, the client application 200 updates the displayed number of search results of the “October 2013” folder. The processing proceeds to step S1007 when the client application 200 determines that the “October 2013” folder is expanded in step S1006. In step S1007, the filter conditions of the folder other than those under the folder showing the difference are deleted from the queue. More specifically, the filter conditions in 1106 and 1107 are deleted from the queue. Because the filter conditions in 1103 to 1105 are remaining in the queue, the result of the determination in step S1009 is Yes, and the processing returns to step S1002 so that the search is executed. As a result, the searches are further executed with the filter conditions in 1103 to 1105. Thus, the processing in FIG. 10 is completed after total of four re-searches are executed.

Example (c) in FIG. 11E illustrates a case where the Add event has occurred. First, in step S1002, the client application 200 executes the search with the filter condition in 1102 in FIG. 11B. In step S1004, the client application 200 determines that January 2013 (“transmission year and month”) has been changed and thus, that there is a difference between the results. In step S1005, the client application 200 updates the displayed number of search results of the “January 2013” folder. The processing proceeds to step S1007 when the client application 200 determines that the “January 2013” folder is expanded in step S1006. In step S1007, the filter conditions of the folder other than those under the folder showing the difference are deleted from the queue. More specifically, the filter conditions in 1103 to 1105 are deleted from the queue. Because the filter conditions in 1106 and 1107 are remaining in the queue, the result of the determination in step S1009 is Yes, and the processing returns to step S1002 so that the search is executed. As a result, the searches are further executed with the filter conditions in 1106 and 1107. Thus, the processing in FIG. 10 is completed after total of three re-searches are executed.

Example (d) in FIG. 11F illustrates a case where the Change event has occurred. First, in step S1002, the client application 200 executes the search with the filter condition in 1102 in FIG. 11B. In step S1004, the client application 200 determines that October 2013 (“transmission year and month”) has been changed but there is no difference between the results. Because the filter conditions in 1103 to 1105 are in the queue, the result of the determination in step S1009 is Yes, and the processing returns to step S1002 so that the search is executed. As a result, searches are sequentially executed with the filter conditions in 1103 to 1105 in this order. When the client application 200 determines that there is a difference between the results in step S1004, the client application 200 updates the display in step S1005. In step S1006, no expanded folder is found, and thus all the filter conditions in the queue are deleted in step S1008, whereby the processing illustrated in FIG. 10 is terminated.

By omitting the search in accordance with an expanded state of the folder showing the difference as described above, a processing cost can be reduced.

More specifically, in the first exemplary embodiment, a search is executed with a search condition associated with a folder (folder in the active tree) selected by the user, when a new event occurs. The search is not executed with a search condition associated with a folder (folder in the non-active tree) that is not selected. Thus, a processing cost in a case where an event has occurred can be reduced.

A second exemplary embodiment is described below. In the first exemplary embodiment described above, the information processing apparatus 101 executes a re-search every time an event occurs. The information processing apparatus 101 according to the second exemplary embodiment may determine whether the event that has newly occurred corresponds to a search condition of each folder in the active tree instead of executing a re-search. Then, the information processing apparatus 101 may increase the total number displayed in association with a folder determined as matching with the search condition corresponding to the event (that is, the displayed number is updated).

For example, when the window 330 is first displayed, the information processing apparatus 101 of the present exemplary embodiment executes a search for a FAX transmission job based on a search condition associated with each folder in the active tree selected by the user among a plurality of folders corresponding to the search condition. The information processing apparatus 101 displays the search result (the number of jobs matching with the search condition) in association with the folder in the active tree selected by the user. Then, upon detecting a new event related to the FAX transmission job, the information processing apparatus 101 determines whether the new FAX transmission job matches with the search condition corresponding to each folder in the active tree selected by the user. The information processing apparatus 101 may increment the number displayed with respect to the folders determined to have matched with the new event.

The exemplary embodiments described above can reduce a processing cost for displaying the number of folders associated with a search condition.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2014-005287 filed Jan. 15, 2014, which is hereby incorporated by reference herein in its entirety.

What is claimed is:

1. An information processing apparatus comprising:
a display control unit configured to execute a job search based on a search condition associated with a folder selected by a user among a plurality of folders associated with search conditions, and to display a search result in association with the selected folder; and
a detection unit configured to detect an event related to a job,
wherein when the event is detected by the detection unit, the display control unit is configured to execute the job search again based on the search condition associated with a folder selected by the user among the plurality of folders, to display a search result in association with the folder, and not to execute the job search based on a search condition associated with a folder not selected by the user.

2. The information processing apparatus according to claim 1, wherein when the event is detected by the detection unit, the display control unit is configured not to execute the job search based on a search condition associated with a folder not selected by the user among the plurality of folders, and not to display the search result to be displayed in association with the folder.

3. The information processing apparatus according to claim 1, wherein when the user changes the selected folder, the display control unit is configured to bring the search result displayed in association with the folder that has been selected before the change, to a nondisplay state.

4. The information processing apparatus according to claim 3, wherein when a search result based on a search condition associated with the newly selected folder is stored, the display control unit is configured to display the search result in association with the folder.

5. The information processing apparatus according to claim 3, wherein when a search result based on a search condition associated with the newly selected folder is not stored, the display control unit is configured to execute the job search based on the search condition associated with the newly selected folder and to display a search result in association with the folder.

6. The information processing apparatus according to claim 1, wherein the display control unit is configured to display a total number of jobs matching with the search condition, as the search result in association with the folder.

7. The information processing apparatus according to claim 1, wherein the display control unit is configured to omit the job search according to an expanded state of the selected folder.

8. An information processing apparatus comprising:
a display control unit configured to execute a job search based on a search condition in association with a folder selected by a user among a plurality of folders associated with search conditions, and to display a search result in association with the selected folder; and
a detection unit configured to detect an event related to a job,
wherein when the event is detected by the detection unit, the display control unit is configured to determine whether a job related to the event matches with the search condition associated with the folder selected by the user, and update a search result displayed in association with a folder determined to have the matching search condition, and
wherein the display control unit is configured not to determine whether the job related to the event matches with a search condition associated with a folder not selected by the user.

9. An information processing method executed by an information processing apparatus, the information processing method comprising:
executing a display control in which a job search is executed based on a search condition associated with a folder selected by a user among a plurality of folders associated with search conditions, and a search result is displayed in association with the selected folder; and
detecting an event related to a job,
wherein in the display control, when the event is detected by the detecting, the job search is executed again based on the search condition associated with the folder selected by the user among the plurality of folders, a search result is displayed in association with the folder, and the job search is not executed based on a search condition associated with a folder not selected by the user.

10. An information processing method executed by an information processing apparatus, the information processing method comprising:
executing display control in which a job search is executed based on a search condition associated with a folder selected by a user among a plurality of folders associated with search conditions, and a search result is displayed in association with the selected folder; and
detecting an event related to a job,
wherein in the display control, when the event is detected by the detecting, whether a job related to the event matches with the search condition associated with the folder selected by the user is determined, and a search result displayed in association with a folder determined to have the matching search condition is updated, and
wherein in the display control, whether the job related to the job matches with a search condition associated with a folder not selected by the user is not determined.

11. A non-transitory computer-readable storage medium storing a computer program for causing a computer to execute:
executing a display control in which a job search is executed based on a search condition associated with a folder selected by a user among a plurality of folders associated with search conditions, and a search result is displayed in association with the selected folder; and
detecting an event related to a job,
wherein in the display control, when the event is detected by the detecting, the job search is executed again based on the search condition associated with the folder selected by the user among the plurality of folders, a search result is displayed in association with the folder, and the job search is not executed based on a search condition associated with a folder not selected by the user.

12. A non-transitory computer-readable storage medium storing a computer program for causing a computer to execute:
executing display control in which a job search is executed based on a search condition associated with a folder selected by a user among a plurality of folders associated with search conditions, and a search result is displayed in association with the selected folder; and
detecting an event related to a job,
wherein in the display control, when the event is detected by the detecting, whether a job related to the event matches with the search condition associated with the folder selected by the user is determined, and a search result displayed in association with a folder determined to have the matching search condition is updated, and
wherein in the display control, whether the job related to the job matches with a search condition associated with a folder not selected by the user is not determined.
